(19) United States
(12) Patent Application Publication
(10) Pub. No.: US 2024/0214694 A1
(43) Pub. Date: Jun. 27, 2024

(54) EPIPOLAR SCAN LINE NEURAL PROCESSOR ARRAYS FOR FOUR-DIMENSIONAL EVENT DETECTION AND IDENTIFICATION

(71) Applicant: Intel Corporation, Santa Clara, CA (US)

(72) Inventor: David Israel Gonzalez-Aguirre, Hillsboro, OR (US)

(21) Appl. No.: 18/456,303

(22) Filed: Aug. 25, 2023

(51) Int. Cl. H04N 23/84; G06T 3/40; H04N 13/128; H04N 13/239

(52) U.S. Cl. CPC H04N 23/84; G06T 3/40; H04N 13/128; H04N 13/239; H04N 13/194

(57) ABSTRACT

Example systems, apparatus, articles of manufacture, and methods are disclosed to implement and utilize epipolar scan line neural processor arrays for four-dimensional event detection and identification. An example apparatus disclosed herein is to generate, based on left input image data and right input image data, left epipolar image data and right epipolar image data, the left epipolar image data including a plurality of left epipolar scan lines, the right epipolar image data including a plurality of right epipolar scan lines. The example apparatus is also to process, with respective neural processors, respective pairs of the left epipolar scan lines and the right epipolar scan lines to detect events represented in the left input image data and the right input image data, and output data packets representative of the detected events.

### FIELD OF THE DISCLOSURE

This disclosure relates generally to video processing and, more particularly, to epipolar scan line neural processor arrays for four-dimensional event detection and identification.

### BACKGROUND

Computer vision applications, such as those employed in autonomous navigation, smart spaces, security, manufacturing, entertainment, etc., utilize event cameras and/or other video processing systems to process stereo image data to detect occupancy events in a volumetric scene represented by the image data. The occupancy events represent changes in the volumetric scene represented by the image data. Such occupancy events can include a spatial addition of a volumetric primitive to the volumetric scene, a spatial deletion of a volumetric primitive from the volumetric scene, and/or an appearance change to a volumetric primitive in the volumetric scene.

### BRIEF DESCRIPTION OF THE DRAWINGS

FIG. 1 is a block diagram of an example event camera including an example epipolar-based event detector and example event stream coordinator circuitry to perform four-dimensional (4D) event detection and identification in accordance with teachings of this disclosure.

FIG. 2 is a block diagram illustrating operation of example color space transformer circuitry included in the example epipolar-based event detector of FIG. 1.

FIG. 3 is a block diagram illustrating operation of example image downsampler circuitry and example epipolar scan line rectifier circuitry included in the example epipolar-based event detector of FIG. 1.

FIGS. 4A-4C illustrate an example of epipolar geometry utilized by the epipolar scan line rectifier circuitry of FIG. 3.

FIG. 5 is a block diagram illustrating an example epipolar scan line neural processor included in the example epipolar-based event detector of FIG. 1.

FIG. 6 illustrates example outputs produced by the example epipolar scan line neural processor array of FIG. 1.

FIGS. 7-8 are flowcharts representative of example machine readable instructions and/or example operations that may be executed, instantiated, and/or performed by example programmable circuitry to implement the epipolar-based event detector and the event stream coordinator circuitry of FIG. 1.

FIG. 9 is a block diagram of an example processing platform including programmable circuitry structured to execute, instantiate, and/or perform the example machine readable instructions and/or perform the example operations of FIGS. 7-8 to implement the epipolar-based event detector and the event stream coordinator circuitry of FIG. 1.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 7-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Example methods, apparatus, systems and articles of manufacture (e.g., physical storage media) to implement and utilize epipolar scan line neural processor arrays for four-dimensional (4D) event detection and identification are disclosed herein. 4D event cameras and other video processing systems that employ such epipolar scan line neural processor arrays can sense and represent 4D space-time occupancy with low-latency performance for computer vision applications, such as those employed in autonomous navigation, smart spaces, security, manufacturing, entertainment, etc. Such event cameras are able to sense and represent 4D space-time occupancy by detecting and identifying occupancy events in a 4D volumetric scene represented by input stereo image data over time. An occupancy event corresponds to a change in presence and/or appearance of a volumetric primitive (e.g., spatial object, region, etc.) in the 4D (e.g., space and time) volumetric scene captured by the stereo cameras. Examples of such occupancy events include a spatial addition of a volumetric primitive to the volumetric scene, a spatial deletion of a volumetric primitive from the volumetric scene, an appearance (e.g., color) change to a volumetric primitive in the volumetric scene, etc., and/or different combinations thereof.

4D event cameras that utilize epipolar scan line neural processor arrays as disclosed herein provide occupancy event detection in four dimensions that is not available in existing two-dimensional (2D) event cameras. 2D event cameras are limited to sensing and transmitting asynchronous pixel-wise appearance changes in which each pixel represents a comparison of the brightness of the pixel to a dynamic reference value for that pixel. As such, the pixels produced by 2D event cameras are referred to as event pixels, which represent signal deviation events when the scene intensity value for a given pixels differs from the last captured value of that pixel by a given threshold θ. Because the deviations do not occur for the entire image all at once (e.g., typically just a few deviation events happen simultaneously within a single image processing cycle), the events are transmitted as a discrete package of information that includes position and intensity attributes. For example, the event pixel information output by a 2D event camera can be the [u, v]∈N² coordinates of the pixel and the intensity change

$$\frac{d}{dt} I ( u , v ) ∈ [ - {2}^{( n - 1 )} , {2}^{( n - 1 )} ] ,$$

which is an n bit resolution signal, usually on the order of n=6 to 7 bits. Thus, a 2D event pixel λᵢ can be represented as:

$${λ}_{i} := [ u , v , \frac{d}{d t} I ( u , v ) , t ] \qquad Equation 1$$

In Equation 1, the event pixel λᵢ output by the 2D event camera for the event i includes the image coordinates u, v of the event, the intensity change

$$\frac{d}{dt} I ( u , v ) > θ$$

for the event, and a time stamp t of the event.

In contrast, an example 4D event camera disclosed herein is able to detect and identify volumetric events in 3D space over time. Furthermore, example 4D event cameras disclosed herein utilize an example epipolar scan line neural processor array that includes an array of individual epipolar scan line neural processors arranged to process scan lines of the input stereo images in parallel, thereby reducing latency relative to prior three-dimensional (3D) event camera. Additionally, to take advantage of the epipolar geometry of the input stereo image data, the scan lines of the input stereo image data are subjected to an epipolar transformation, also referred to as epipolar rectification or epipolar unwrapping, prior to processing by the epipolar scan line neural processors, thereby enabling accurate detection of occupancy events in a 3D volumetric scene. Furthermore, due to the low latency achievable by processing the epipolar scan lines in parallel with the array of epipolar scan line neural processors, a 4D event camera utilizing the epipolar scan line neural processor array can achieve real-time occupancy event detection and identification in support of 4D computer vision applications.

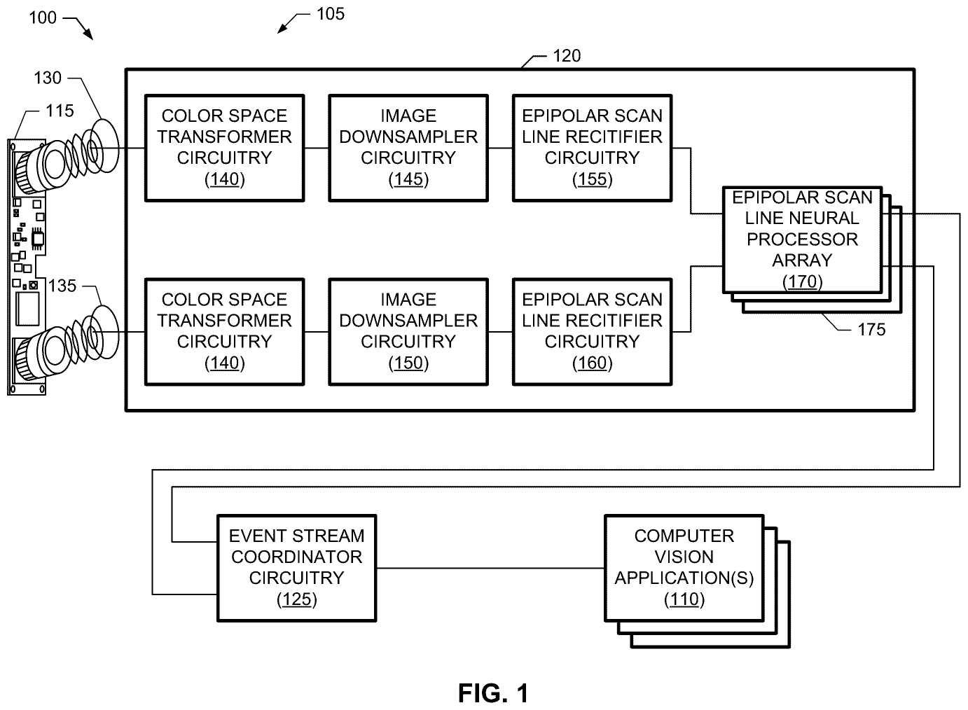

FIG. 1 is a block diagram of an example environment 100 including an example 4D event camera 105 to perform 4D event detection and identification for use by one or more example computer vision applications 110. The 4D event camera 105 of the illustrated example includes example stereo imagers 115, an example epipolar-based event detector 120, and example event stream coordinator circuitry 125. The stereo imagers 115 include an example left imager 130 and an example right imager 135 that operate to capture left and right input images, respectively, of a volumetric scene of interest. The left imager 130 and the right imager 135 can be implemented by any suitable image capturing devices, such as visible light cameras, infrared cameras, optical sensors, etc. Furthermore, the left imager 130 and the right imager 135 can implement global shutters that capture an entire image of the scene at each sample time based on an image capture rate, and/or rolling shutters that sequentially capture scan lines of the image of the scene at a subsampling rate of the image capture rate based on the number of scan lines included in the entire image.

The example epipolar-based event detector 120 of FIG. 1 is to detect and identify occupancy events in the volumetric scene represented by stereo input image data from the stereo imagers 115. The epipolar-based event detector 120 of FIG. 1 may be instantiated (e.g., creating an instance of, bring into being for any length of time, materialize, implement, etc.) by programmable circuitry such as a Central Processor Unit (CPU) or Vision Processing Unit (VPU) executing first instructions. Additionally or alternatively, the epipolar-based event detector 120 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of the epipolar-based event detector 120 of FIG. 1 may, thus, be instantiated at the same or different times. Some or all of the circuitry of the epipolar-based event detector 120 of FIG. 1 may be instantiated, for example, in one or more threads executing concurrently on hardware and/or in series on hardware. Moreover, in some examples, some or all of the circuitry of the epipolar-based event detector 120 of FIG. 1 may be implemented by microprocessor circuitry executing instructions and/or FPGA circuitry performing operations to implement one or more virtual machines and/or containers.

The epipolar-based event detector 120 of the illustrated example includes example left and right color space transformer circuitry 140 and 145, example left and right image downsampler circuitry 150 and 155, example left and right epipolar scan line rectifier circuitry 160 and 165, and an example epipolar scan line neural processor array 170. The epipolar scan line neural processor array 170 of the illustrated example is an array of example epipolar scan line neural processors 175, with the number of epipolar scan line neural processor 175 corresponding to the number of input scan lines in the images processed by the epipolar scan line neural processor array 170. In the illustrated example, each epipolar scan line neural processor 175 is responsible for processing a respective pair of scan lines from the left and right images applied to the input of the epipolar scan line neural processor array 170, thereby enabling the pairs of scan lines of the left and right images to be processed in parallel.

As disclosed in further detail below, a given epipolar scan line neural processor 175 operates on a given pair of scan lines resulting from epipolar rectification to estimate the disparities between corresponding pixels of the left and right scan lines in the pair. Due to the epipolar geometry of the volumetric scene captured by the stereo imagers 115, the disparities between pixels of the left input image and corresponding pixels of right input image are related to (e.g., proportional to) the depths (e.g., distances from the imagers 115) of the volumetric elements (e.g., voxels) represented by those corresponding pixels. In some examples, the epipolar scan line neural processor 175 estimates the disparities between corresponding pixels of the left and right input scan lines to detect appearance events by computing neural chromatic and/or intensity cross-correlations for each implicit voxel, which is embodied by a pixel representing a volumetric region, along a search band bounded by minimal and maximal disparities as imposed by minimal and maximal object distances (e.g., the near and far clipping planes) known for the volumetric scene being captured by the stereo imagers 115. In some examples, the epipolar scan line neural processor 175 then compares differences between the voxel disparities computed for the current input scan line pair and those computed for a previous process iteration, and outputs occupancy events for disparity deviations that are below or above one or more thresholds calibrated during training and/or provided as user settings. Examples of such occupancy events include a spatial addition of a volumetric primitive (e.g., voxel) to the volumetric scene, a spatial deletion of a volumetric primitive (e.g., voxel) from the volumetric scene, an appearance (e.g., color) change to a volumetric primitive (e.g., voxel) in the volumetric scene, etc., and/or different combinations thereof. For example, the epipolar scan line neural processor 175 may compare previous depths for voxel disparities computed during a prior process iteration to current depths for voxel disparities computed during a current process iteration to detect positive spatial addition events, negative spatial deletion events, etc. The epipolar scan line neural processor 175 repeats this processing in successive process iterations for input scan lines obtained at successive image capture times/intervals.

The example event stream coordinator circuitry 125 of FIG. 1 is to package and output/transmit occupancy events detected by the epipolar-based event detector 120. The example event stream coordinator circuitry 125 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the event stream coordinator circuitry 125 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of the event stream coordinator circuitry 125 of FIG. 1 may, thus, be instantiated at the same or different times. Some or all of the circuitry of the event stream coordinator circuitry 125 of FIG. 1 may be instantiated, for example, in one or more threads executing concurrently on hardware and/or in series on hardware. Moreover, in some examples, some or all of the circuitry of the event stream coordinator circuitry 125 of FIG. 1 may be implemented by microprocessor circuitry executing instructions and/or FPGA circuitry performing operations to implement one or more virtual machines and/or containers.

The event stream coordinator circuitry 125 of the illustrated example operates to package the occupancy events detected by the epipolar-based event detector 120 into data structures, such as data objects, data arrays, data packets, etc., to be output and/or transmitted to one or more of the computer visions applications 110. For example, the event stream coordinator circuitry 125 may package the occupancy events into data objects and/or data arrays to be output (e.g., passed) to one or more of the computer visions applications 110. In some examples, the event stream coordinator circuitry 125 packages the occupancy events into data packets to be transmitted (e.g., streamed) to one or more of the computer visions applications 110 and/or broadcast to one or more receiving devices (e.g., workstations) via a wired and/or wireless network connection (e.g., Ethernet, Wi-Fi, etc.), a cabled connection (e.g., a universal serial bus (USB) connection, an optical connection, etc.), etc. In some examples, the event stream coordinator circuitry 125 also adaptively steers the thresholding parameters used by the epipolar-based event detector 120 to limit the number of transmitted data packets/messages to be within a bandwidth target.

Together, the epipolar-based event detector 120 and the event stream coordinator circuitry 125 provide occupancy event detection and identification that inherently compresses the amount of information be output/transmitted, even for high resolution images. Thus, the operation frequency of the 4D event camera 105 can be on the order of kilohertz (KHz), rather than megahertz (MHz) as in case of 2D event cameras. Furthermore, the utilization of epipolar geometry and parallelization in epipolar-based event detector 120 provides a balanced distribution between refresh-rate and point change density, which translates into responsive scene analyses with bounded data throughput.

As noted above, the computer vision applications 110 can be any computer vision applications, such as those employed in autonomous navigation, smart spaces, security, manufacturing, entertainment, etc. As such, the computer vision applications 110 can use the occupancy events output from the 4D event camera 105 to detect and track objects in the volumetric scene monitored by the 4D event camera 105. Furthermore, although the epipolar-based event detector 120 and the event stream coordinator circuitry 125 are described in the context of implementation in the 4D event camera 105, the epipolar-based event detector 120 and the event stream coordinator circuitry 125 could also be implemented in a video processing system separate from the imagers 115 and/or other elements of the 4D event camera 105.

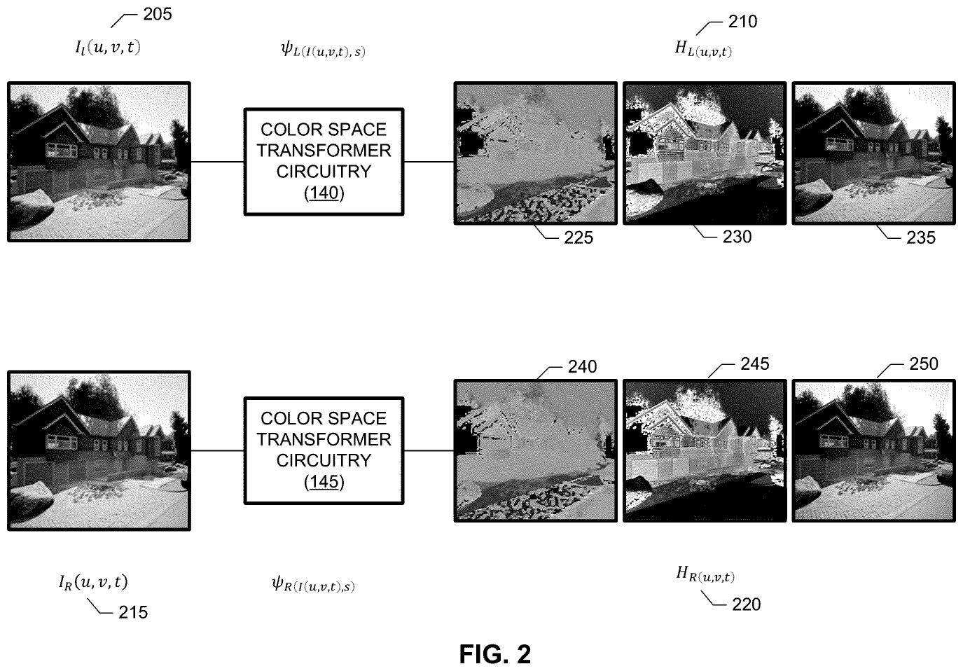

Further implementation and operation details of the example epipolar-based event detector 120 of FIG. 1 are provided in FIGS. 2-6. FIG. 2 is a block diagram illustrating example operation of the color space transformer circuitry 140 and 145 included in the example epipolar-based event detector 120 of FIG. 1. As shown in FIG. 2, the color space transformer circuitry 140 and 145 operates on left and right input images I_{k(u,v,t)}, k∈{L, R} where L represents left and R represents right, from the stereo imagers 115 to transform the input images I_{k(u,v,t)} obtained at capture time t from a first color space (e.g., a red-green-blue, or RGB, color space) to a second color space (e.g., the hue-saturation-value, or HSV, color space, a LAB color space, etc.). However, in some examples, the color space transformer circuitry 140 and 145 can be implemented to handle up to any number n of input images I_{k(u,v,t)}, k∈{1 . . . n} from n imagers/sensors. The color space transformation performed by the color space transformer circuitry 140 and 145 can be represented by the color space mapping function, p. As such, the color space transformation performed by the left color space transformer circuitry 140 can be represented mathematically by Equation 2, which is:

$${H}_{L ( u , v , t )} = ψ ( {I}_{L ( u , v , t )} ) \qquad Equation 2$$

In Equation 2, I_{L(u,v,t)} corresponds to an example left input image 205 from the left imager 130, ψ corresponds to the color space transformation implemented by the left color space transformer circuitry 140, and H_{L(u,v,t)} corresponds to an example left transformed input image 210 output from the left color space transformer circuitry 140. Likewise, the color space transformation performed by the right color space transformer circuitry 145 can be represented mathematically by Equation 3, which is:

$${H}_{R ( u , v , t )} = ψ ( {I}_{R ( u , v , t )} ) \qquad Equation 3$$

In Equation 3, I_{R(u,v,t)} corresponds to an example right input image 215 from the right imager 135, ψ corresponds to the color space transformation implemented by the right color space transformer circuitry 145, and H_{R(u,v,t)} corresponds to an example right transformed input image 220 output from the right color space transformer circuitry 145.

In Equations 2 and 3, the variable u represents the pixel index over the height of the images 205, 210, 215 and 220, and ranges over [0, (H−1)], where H is the height of the images in pixels. In Equations 2 and 3, the variable v represents the pixel index over the width of the images 205, 210, 215 and 220, and ranges over [0, (W−1)], where W is the width of the images in pixels. In Equations 2 and 3, the variable t represents the capture time of the input images 205 and 215.

Also, in the illustrated example of FIG. 2, the resulting transformed input images 210 and 220 each have three components, which correspond to the example components 225, 230 and 235 for the left transformed input image 210, and the example components 240, 245 and 250 for the right transformed input image 220. In the illustrated example, the resulting transformed input images 210 and 220 are HSV transformed images. As such, the example components 225, 230 and 235 for the left transformed input image 210 include an example hue component 225, an example saturation component 230, and an example intensity component 235. Likewise, the example components 240, 245 and 250 for the right transformed input image 220 include an example hue component 240, an example saturation component 245, and an example intensity component 250.

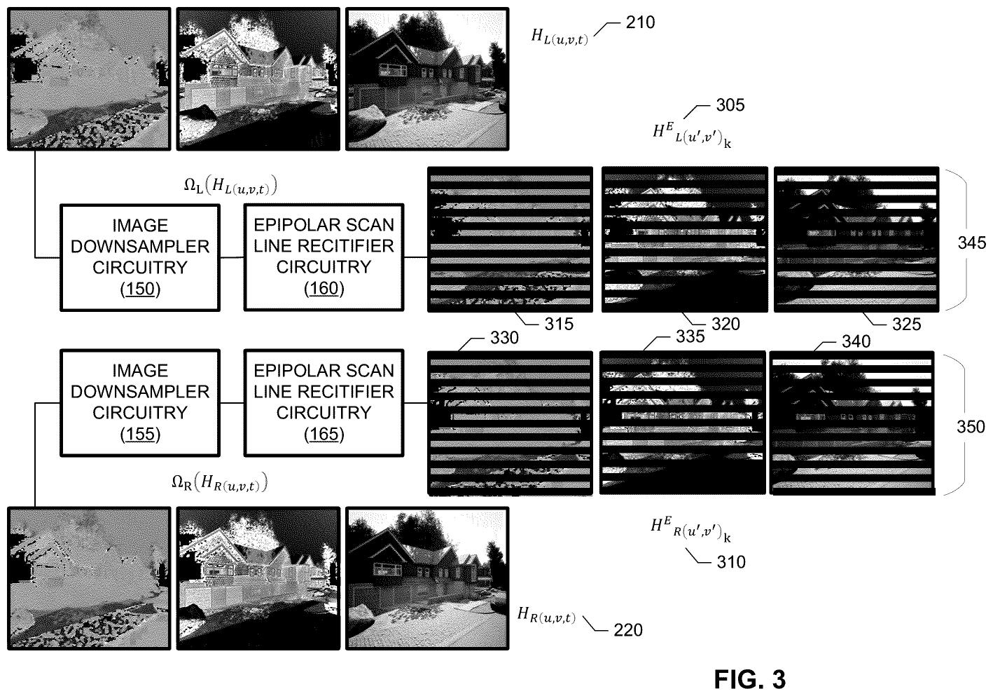

FIG. 3 is a block diagram illustrating example operation of the left and right image downsampler circuitry 150 and 155 and the left and right epipolar scan line rectifier circuitry 160 and 165 included in the example epipolar-based event detector 120 of FIG. 1. As shown in FIG. 3, the image downsampler circuitry 150 and 155 downsamples the left and right transformed input images H_{k(u,v,t)}, k∈{L, R}, by a downsample factor of 2^{s}, s≥0, to yield downsampled versions of the left and right transformed input images H_{k(u′,v′,t)}, k∈{L, R}, that are indexed by downsampled versions u′, v′ of the image pixel indices u, v. The downsample parameter s specifies the amount of downsampling to be performed by the image downsampler circuitry 150 and 155. In some examples, the image downsampler circuitry 150 and 155 is also referred to as adjustable downsampler (ADS) circuitry 150 and 155 in examples in which the downsample parameter s can be changed dynamically to trade-off image resolution for processing latency (e.g., with higher resolution images resulting in higher processing latency, and lower resolution images resulting in lower processing latency). For example, a downsampling parameter of s=0 yields a downsample factor of 2⁰=1, which means that no downsampling is performed. A down sampling parameter of s=1 yields a downsample factor of 2¹=2, which means the left and right transformed input images will be downsampled to ½ their original size. A down sampling parameter of s=2 yields a downsample factor of 2²=4 which means the left and right transformed input images will be downsampled to ¼ their original size, and so on. Thus, if the pixel dimensions of the transformed input images are height H and width W, then the downsampled input images output from the image downsampler circuitry 150 and 155 will have a height of H′=[H/2^{s}], and a width of W′=[W/2^{s}].

As shown in FIG. 3, the epipolar scan line rectifier circuitry 160 and 165 rectify the downsampled input images H_{k(u′,v′,t)}, k∈{L, R}, from the image downsampler circuitry 150 and 155 to produce rectified input images H_{k(u′,v′,t)}^{E}, k∈{L, R}. In the illustrated example, the left and right epipolar scan line rectifier circuitry 160 and 165 utilize respective epipolar transforms, represented by Ωₖ, k∈{L, R}, to rectify the downsampled input images H_{k(u′,v′,t)}, k∈{L, R}, based on the epipolar geometry of the volumetric scene captured by the stereo imagers 115. Thus, the rectified input images are also referred to as epipolar input images H_{k(u′,v′,t)}^{E}, k∈{L, R}.

In some examples, the left and right epipolar scan line rectifier circuitry 160 and 165 implement their respective epipolar transforms using respective fundamental matrices that are computed based on the geometry of the stereo imagers 115, such as their respective positions, focal planes, etc. In some examples, the geometry of the stereo imagers 115 can be specified as configuration information input to the 4D event camera 105 via a software development kit (SDK) and/or other configuration interface.

Mathematically, the downsampling and rectification, or epipolar transformation, performed by the left image downsampler circuitry 150 and the left epipolar scan line rectifier circuitry 160 can be represented by Equation 4, which is:

$${H}_{L ( {u}^{′} , {v}^{′} , t )}^{E} = {Ω}_{L} ( {H}_{L ( u , v , t )} ) \qquad Equation 4$$

In Equation 4, H_{L(u,v,t)} corresponds to the example left transformed input image 210 from the left color space transformer circuitry 140, Ω_{L} corresponds to the downsampling performed by the left image downsampler circuitry 150 and the epipolar transformation implemented by the left epipolar scan line rectifier circuitry 160, and H^{E}_{L(u′,v′,t)} corresponds to an example left epipolar input image 305 output from the left epipolar scan line rectifier circuitry 160. Likewise, the downsampling and rectification, or epipolar transformation, performed by the right image downsampler circuitry 155 and the right epipolar scan line rectifier circuitry 165 can be represented by Equation 5, which is:

$${H}_{R ( {u}^{′} , {v}^{′} , t )}^{E} = {Ω}_{L} ( {H}_{R ( u , v , t )} ) \qquad Equation 5$$

In Equation 5, H_{R(u,v,t)} corresponds to the example right transformed input image 220 from the right color space transformer circuitry 145, Ω_{R} corresponds to the downsampling performed by the right image downsampler circuitry 155 and the epipolar transformation implemented by the right epipolar scan line rectifier circuitry 165, and H^{E}_{R(u′,v′,t)} corresponds to an example right epipolar input image 310 output from the right epipolar scan line rectifier circuitry 165.

In Equations 4 and 5, the variable u represents the pixel index over the height of the transformed images 210 and 220, and ranges over [0, (H−1)], where His the height of the images in pixels. In Equations 4 and 5, the variable v represents the pixel index over the width of the transformed images 210 and 220, and ranges over [0, (W−1)], where W is the width of the images in pixels. In Equations 4 and 5, the variable u′ represents the pixel index over the height of the downsampled, epipolar images 305 and 310, and ranges over [0, H′=(H−1)/2^{s}], where H′=(H−1)/2^{s} is the height of the downsampled, epipolar images 305 and 310 in pixels. In Equations 4 and 5, the variable v′ represents the pixel index over the width of the downsampled, epipolar images 305 and 310, and ranges over [0, W′=(W−1)/2^{s}], where W′=(W−1)/2^{s} is the width of the downsampled, epipolar images 305 and 310 in pixels. In Equations 4 and 5, the variable t represents the capture time of the input images 205 and 215.

Also, in the illustrated example of FIG. 2, the resulting downsampled, epipolar images 305 and 310 each have three components, which correspond to the example components 315, 320 and 325 for the left downsampled, epipolar image 305, and the example components 330, 335 and 340 for the downsampled, epipolar image 310. In the illustrated example, the resulting downsampled, epipolar images 305 and 310 are HSV epipolar images. As such, the example components 315, 320 and 325 for the left downsampled, epipolar image 305 include an example hue component 315, an example saturation component 320, and an example intensity component 325. Likewise, the example components 330, 335 and 340 for the right downsampled, epipolar image 310 include an example hue component 330, an example saturation component 335, and an example intensity component 340.

As further shown in FIG. 3, the left and right epipolar images 305 and 310 output from the left and right epipolar scan line rectifier circuitry 160 and 165 include example epipolar scan lines 345 and 350, which are akin to the scan lines of the original input images 205 and 210, but which have been transformed, or distorted, based on the epipolar transformations to represent the epipolar geometry of the volumetric scene captured by the stereo imagers 115. Also, as a result of the epipolar transformations, there is a one-to-one correspondence between the left scan lines 345 of the left epipolar image 305 and the right scan lines 350 of the right epipolar image 310. For example, the first scan line of the left epipolar image 305 corresponds to the first scan line of the right epipolar image 310, the second scan line of the left epipolar image 305 corresponds to the second scan line of the right epipolar image 310, the third scan line of the left epipolar image 305 corresponds to the third scan line of the right epipolar image 310, and so on, with the H′−1 scan line of the left epipolar image 305 corresponding to the H′−1 scan line of the right epipolar image 310. Thus, each pair of corresponding left and right input scan lines from the left epipolar image 305 and the right epipolar image 310 can be processed independently of the other pairs of corresponding left and right input scan lines to determine the volumetric elements, or voxels, represented by correlated pairs of left and right pixels in the given pair of corresponding left and right input scan lines being processed.

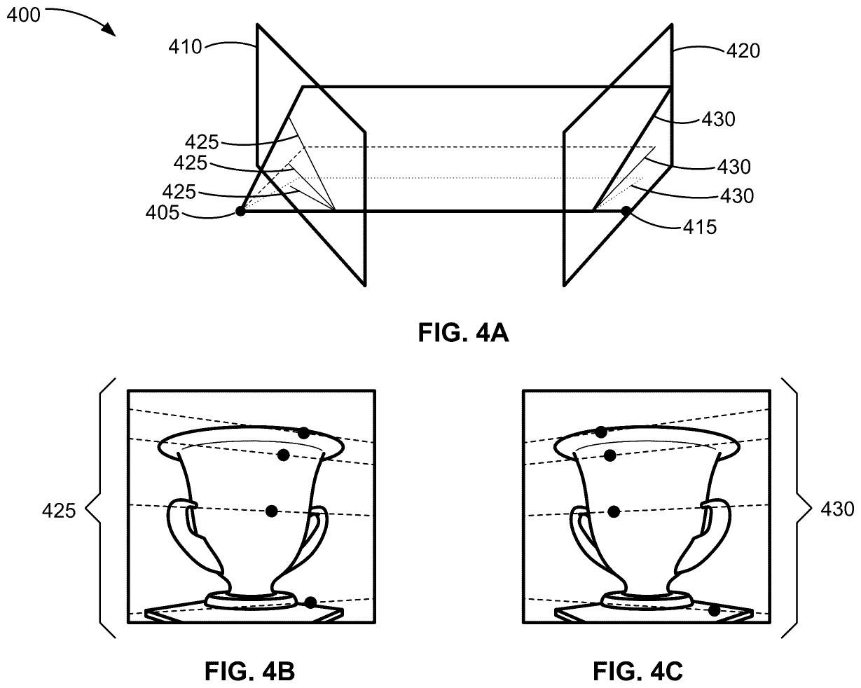

FIGS. 4A-4C illustrate an example of epipolar geometry that forms the basis of the epipolar transformations utilized by the epipolar scan line rectifier circuitry 160 and 165 of FIG. 3. FIG. 4A illustrates an example epipolar geometry 400 corresponding to the left imager 130 and the right imager 135 of the stereo imagers 115. The epipolar geometry 400 of the illustrated example includes an example left optical center 405 and an example left image plane 410 corresponding to the position of the left imager 130. The epipolar geometry 400 of the illustrated example also includes an example right optical center 415 and an example right image plane 420 corresponding to the position of the right imager 130. Based on the relative positions and angles of the left optical center 405, the left image plane 410, the right optical center 415 and the right image plane 420, points in the 3D volumetric scene captured by the stereo imagers 115 will lie on corresponding example epipolar lines 425 and 430 of respective left and right images captured by the left imager 130 and the right imager 135. Example left and right images 435 and 440 illustrating the epipolar lines 425 and 430 are depicted in FIGS. 4B and 4C.

As described above, the left epipolar scan line rectifier circuitry 160 and the right epipolar scan line rectifier circuitry 165 perform respective epipolar rectification operations on the respective left and right images captured by the left imager 130 and the right imager 135 to generate rectified images for processing by the epipolar scan line neural processor array 170. The rectification operations transform the epipolar lines 425 and 430 of the left and right images captured by the left imager 130 and the right imager 135 into corresponding horizontal lines to facilitate matching pixels in the left and right images that correspond to the same points in the captured 3D volumetric scene. In some examples, the left scan line rectifier circuitry 160 implements epipolar rectification by applying a left fundamental matrix to the left image H_{L(u,v,t)} captured by the left imager 130 to generate the left rectified image H^{E}_{L(u′,v′,t)} for processing by the epipolar scan line neural processor 17. Likewise, in some examples, the right scan line rectifier circuitry 165 implements epipolar rectification by applying a right fundamental matrix to the right image H_{R(u,v,t)} captured by the right imager 135 to generate the right rectified image H^{E}_{R(u′,v′,t)} for processing by the epipolar scan line neural processor 17. In some such examples, the left and right scan line rectifier circuitry 160 and 165 utilize any appropriate technique to compute their respective left and right fundamental matrices based on the relative positions and angles of the left optical center 405, the left image plane 410, the right optical center 415 and the right image plane 420 of the left and right imagers 130 as provided during manufacturing and/or user operation via an SDK and/or other configuration interface.

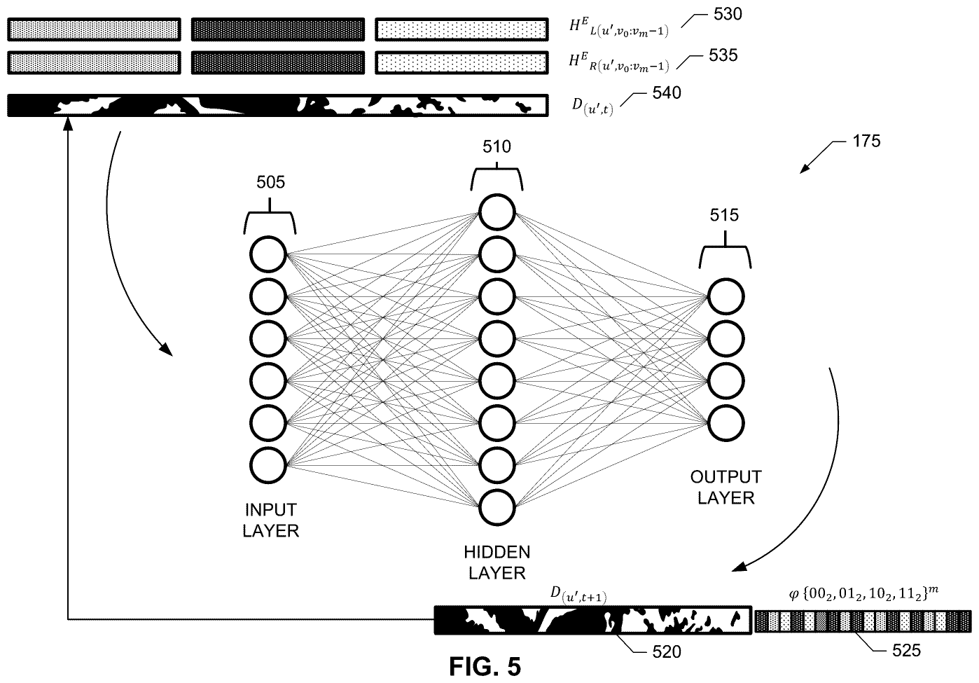

FIG. 5 is a block diagram illustrating an example epipolar scan line neural processor 175 included in the example epipolar scan line neural processor array 170 of the example epipolar-based event detector 120 of FIG. 1. At a high-level, the epipolar scan line neural processor array 170 operates to correlate pixels of the left and right epipolar images 305 and 310 that correspond to a same volumetric element, or voxel, in the volumetric space captured by the stereo imagers 115. For a given pair of pixels in the left and right epipolar images 305 and 310 that are determined to be correlated to the same volumetric element, or voxel, in the volumetric space, the epipolar scan line neural processor array 170 further determines the disparity between the locations of that pair of pixels in the left and right epipolar images 305 and 310. Due to the stereo configuration of the stereo images 115, that disparity is related to (e.g., proportional to) the depth, or distance, of the volumetric element from the stereo images 115. Thus, the epipolar scan line neural processor array 170 is able to estimate depth from the left and right epipolar images 305 and 310.

Furthermore, due to the epipolar transformations performed by the left and right epipolar scan line rectifier circuitry 160 and 165 to obtain the left and right epipolar images 305 and 310, pixels in the left and right epipolar images 305 and 310 that correlate to the same volumetric element, or voxel, in the volumetric space will be located on the same scan line in the left and right epipolar images 305 and 310. Thus, based on the notation provided in the discussion of FIG. 3 above, the epipolar scan line neural processor array 170 of the epipolar-based event detector 120 includes an array of H′=(H−1)/2^{s} epipolar scan line neural processors 175, with each epipolar scan line neural processor 175 configured to process a pair of corresponding scan lines from the left and right epipolar images 305 and 310 output from the left and right epipolar scan line rectifier circuitry 160 and 165.

Mathematically, using Tᵢ to represent the i^{th} epipolar scan line neural processor 175 in the epipolar scan line neural processor array 170, the left epipolar image H^{E}_{L(u′,v′,t)} and the right epipolar image H^{E}_{R(u′,v′,t)} are processed by an array of i∈[0, H′=(H−1)/2\hat{ }s] epipolar scan line neural processors Tᵢ to output a disparity map D representing the disparities between correlated pixels of the left epipolar image H^{E}_{L(u′,v′,t)} and the right epipolar image H^{E}_{R(u′,v′,t)}. Furthermore, due to the epipolar transformation used to obtain the left epipolar image H^{E}_{L(u′,v′,t)} and the right epipolar image H^{E}_{R(u′,v′,t)}, each of the epipolar scan line neural processors Tᵢ is structured to process a respective pair of the i^{th} corresponding left and right scan lines

$${{H}^{E}}_{L ( {u}_{i}^{′} , {v}_{o}^{′} : {v}_{{w}^{′} - 1}^{′} , t )} and {{H}^{E}}_{R ( {u}_{i}^{′} , {v}_{o}^{′} : {v}_{{w}^{′} - 1}^{′} , t )}$$

from the left and right epipolar images H^{E}_{L(u′,v′,t)} and H^{E}_{R(u′,v′,t)}, respectively, to output a disparity vector D_{(u′}_{ᵢ}_{,t)} and an event vector φ_{(u′}_{ᵢ}_{,t)} for the i^{th} corresponding scan lines. The disparity vector D_{(u′}_{ᵢ}_{,t)} is a vector of values representing the disparities, or positional differences in number of pixels, between pixels in the i^{th} left and right scan lines

$${{H}^{E}}_{L ( {u}_{i}^{′} , {v}_{o}^{′} : {v}_{{w}^{′} - 1}^{′} , t )} and {{H}^{E}}_{R ( {u}_{i}^{′} , {v}_{o}^{′} : {v}_{{w}^{′} - 1}^{′} , t )}$$

estimated by the epipolar scan line neural processor Tᵢ to be matches (e.g., the displacement from each pixel in one epipolar scan line to its best match in the other epipolar scan line of the pair of left and right epipolar scan lines). In addition to determining such disparities, the epipolar scan line neural processor Tᵢ also compares the changes in the disparity vectors D_{(u′}_{ᵢ}_{,t)} over time, as well as the color changes of the matching pixels over time, to one or more thresholds to output an event vector φ_{(u′}_{ᵢ}_{,t)} for the i^{th} corresponding scan lines which indicated whether a spatial event, a color (e.g., chromatic) event or a dual spatial and color event is detected for the volumetric elements, or voxels, corresponding the matching pixels in the i^{th} left and right scan lines

$${{H}^{E}}_{L ( {u}_{i}^{′} , {v}_{o}^{′} : {v}_{{w}^{′} - 1}^{′} , t )} and {{H}^{E}}_{R ( {u}_{i}^{′} , {v}_{o}^{′} : {v}_{{w}^{′} - 1}^{′} , t )} .$$

Thus, the output of the epipolar scan line neural processor Tᵢ for the i^{th} left and right scan lines

$${{H}^{E}}_{L ( {u}_{i}^{′} , {v}_{o}^{′} : {v}_{{w}^{′} - 1}^{′} , t )} and {{H}^{E}}_{R ( {u}_{i}^{′} , {v}_{o}^{′} : {v}_{{w}^{′} - 1}^{′} , t )}$$

can be represented mathematically by Equation 6, which is:

$${T}_{u ( {{H}^{E}}_{L ( {u}_{i}^{′} , {v}_{o}^{′} : {v}_{{w}^{′} - 1}^{′} , t )} , {{H}^{E}}_{R ( {u}_{i}^{′} , {v}_{o}^{′} : {v}_{{w}^{′} - 1}^{′} , t )} , {D}_{( {u}_{i}^{′} , t - 1 )} )} ↦ [ \text{} {D}_{( {u}_{i}^{′} , t )} ∈ {R}^{m} , φ ∈ {\{ {00}_{2} , {01}_{2} , {10}_{2} , {11}_{2} \}}^{m} ] \qquad Equation 6$$

With reference to FIG. 5, the epipolar scan line neural processor 175 (e.g., Tᵢ) illustrated therein includes an example input layer 505, one or more example hidden layers 510 and an example output layer 515 to implement a multi-layer perceptron (MLP), an artificial neural network (ANN) and/or any other machine learning processor to estimate the disparity vector 520 (D_{(u′}_{ᵢ}_{,t)}) and the event vector 525 (φ_{(u′}_{ᵢ}_{,t)}) for the i^{th} corresponding left scan line 530

$$( {{H}^{E}}_{L ( {u}_{i}^{′} , {v}_{o}^{′} : {v}_{{w}^{′} - 1}^{′} , t )} )$$

and right scan line 535

$$( {{H}^{E}}_{R ( {u}_{i}^{′} , {v}_{o}^{′} : {v}_{{w}^{′} - 1}^{′} , t )} )$$

applied to the input layer 505. Additionally, the disparity vector 540 (D_{(u′}_{ᵢ}_{,t-1)}) from a prior processing iteration corresponding to the previously captured input images is also applied to the input layer 505 of the epipolar scan line neural processor 175 (e.g., Tᵢ).

In the illustrated example, the event vector 525 (φ_{(u′}_{ᵢ}_{,t)}) includes values (e.g., flags) to indicate that a given volumetric element, or voxel, is associated with one of a number of possible event types. In some examples, there may be four possible event types corresponding to a spatial event, a chromatic event, a dual spatial and chromatic event, or no event. For example, the spatial event type may be detected by the epipolar scan line neural processor 175 (e.g., Tᵢ) when the change in disparity at a pixel location of the i^{th} scan line pair exceeds a first threshold or is below a second threshold indicating addition or subtraction, respectively, of a volumetric element, or voxel, corresponding to that pixel location. As another example, the chromatic event type may be detected by the epipolar scan line neural processor 175 (e.g., Tᵢ) when the change in pixel color at a matching pixel location of the i^{th} scan line pair exceeds a threshold. As yet another example, the dual spatial and chromatic event may be detected by the epipolar scan line neural processor 175 (e.g., Tᵢ) when both a spatial event and a chromatic event are detected for a matching pixel location of the i^{th} scan line pair. As yet a further example, the no event type, or null event type, may be indicated when the epipolar scan line neural processor 175 (e.g., Tᵢ) does not detect any event for a matching pixel location of the i^{th} scan line pair. In some examples, the different event types are represented by binary values, such as φⱼ=01₂ for a chromatic event φⱼ=10₂ for a spatial event, φⱼ=11₂ for a dual spatial and chromatic event, and φⱼ=00₂ for no event, where j∈{0, . . . , W′−1} epipolar volumetric elements in the i^{th} scan line pair.

In some examples, the input layer 505, the hidden layer(s) 510 and the output layer 515 of the epipolar scan line neural processor 175 (e.g., Tᵢ) are configured by operating the 4D event camera with training data during a training phase. Likewise, in some examples, the threshold(s) employed by the epipolar scan line neural processor 175 (e.g., Tᵢ) are configured by operating the 4D event camera with training data during a training phase. In some examples, the the input layer 505, the hidden layer(s) 510, the output layer 515 and the threshold(s) employed by the epipolar scan line neural processor 175 (e.g., Tᵢ) are trained separately from the 4D event camera 105 and then downloaded to the 4D event camera 105.

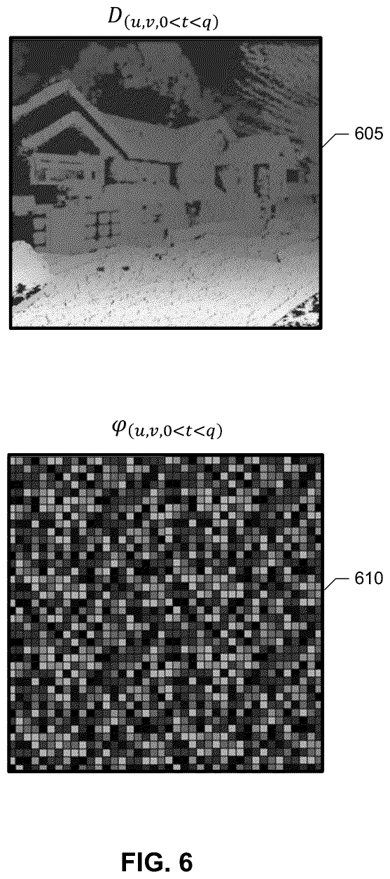

FIG. 6 illustrates example outputs produced by the example epipolar scan line neural processor array 170 of FIG. 1. The example outputs include an example depth image 605 determined by concatenating the disparity vectors 520 (D(u t)) output by the epipolar scan line neural processors 175 (Tᵢ) over i∈{0, . . . , H′−1} left and right epipolar scan line pairs. In the illustrated example, larger disparity values are depicted in lighter colors, which demonstrates how disparity is related (e.g., proportional) to depth. For example, in the depth image 605, lighter colors are associated with larger disparity values which correspond to smaller depths (e.g., closer to the stereo imagers 115), whereas darker colors are associated with smaller disparity values which correspond to larger depths (e.g., farther from the stereo imagers 115).

In the illustrated example, the outputs also include an example event image 610 determined by concatenating the event vectors 525 (φ_{(u′}_{ᵢ}_{,t)}) output by the epipolar scan line neural processors 175 (Tᵢ) over i∈{0, . . . , H′−1} left and right epipolar scan line pairs. In the illustrated example, different event type values are represented by different colors.

In some examples, for those pixels in the resulting depth image 605 describing a voxel that is not associated with a null event (or no event), the event stream coordinator circuitry 125 creates an event data structure or event data packet that is output and/or transmitted by the 4D event camera 105. For example, for a voxel associated with a spatial event, the event stream coordinator circuitry 125 creates an event data structure or event data packet represented by Equation 7, which is:

$${λ}_{i}^{s} := [ {\underbrace{{x}_{c} = {ω}_{x} ( {u}_{L}^{′} , {v}_{L}^{′} , {u}_{R}^{′} , {v}_{R}^{′} )}}_{X center of Voxel} , {\underbrace{{y}_{c} = {ω}_{y} ( {u}_{L}^{′} , {v}_{L}^{′} , {u}_{R}^{′} , {v}_{R}^{′} )}}_{{Y center of Voxel}_{{\underbrace{\pm r ∈ {R}^{3}}}_{{Voxel Radius ,}_{{( sign encodes}_{{addition or}_{subtraction )}}}} , {\underbrace{t}}_{Event Time}}} , {\underbrace{{z}_{c} = {ω}_{z} ( {u}_{L}^{′} , {v}_{L}^{′} , {u}_{R}^{′} , {v}_{R}^{′} )}}_{Z center of Voxel} , ] \qquad Equation 7$$

Thus, the spatial event data structure or data packet of Equation 7 includes the center (x_{c},y_{c},z_{c}) of the voxel corresponding to the spatial event in the x, y and z dimensions, a radius r of the voxel in the volumetric scene, and the time t of the voxel. In Equation 7, the event stream coordinator circuitry 125 utilizes the functions ωₓ, ω_{y}, and ω_{z} compute the spatial center of the voxel corresponding to the spatial event in the x, y and z dimensions via triangulation using the coordinates of the voxel's matching pixels in the left and right epipolar images and the known epipolar geometry of the volumetric scene. In Equation 7, the event stream coordinator circuitry 125 computes the radius r of the voxel based on the location of the voxel in the epipolar geometry and the downsampling factor implemented by the downsampler circuitry 150 and 155. The sign of the radius indicates whether the voxel corresponds to an addition or a subtracting in the volumetric scene.

As another example, for a voxel associated with a chromatic event, the event stream coordinator circuitry 125 creates an event data structure or event data packet represented by Equation 8, which is:

$${λ}_{i}^{c} := [ {\underbrace{{u}_{L}^{′} , {v}_{L}^{′}}}_{{Left - image}_{Pixel coordinates}} , {\underbrace{{u}_{R}^{′} , {v}_{R}^{′}}}_{{Right - image}_{Pixel coordinates}} , {\underbrace{\frac{d}{dt} {H}_{L}^{E} ( {u}_{L}^{′} , {v}_{L}^{′} , t )}}_{Left - image Appearance Change} ∈ {N}^{3} , {\underbrace{\frac{d}{dt} {H}_{R}^{E} ( {u}_{R}^{′} , {v}_{R}^{′} , t ) ∈ {N}^{3}}}_{Right - image Appearance Change} , t ] \qquad Equation 8$$

Thus, the chromatic event data structure or data packet of Equation 8 includes the left pixel coordinate u′_{L}, v′_{L} of the left epipolar image and the right pixel coordinate u′_{R}, v′_{R} of the right epipolar image corresponding to the chromatic event, the detected change

$$\frac{d}{dt} {H}_{L}^{E} ( {u}_{L}^{′} , {v}_{L}^{′} , t )$$

in the appearance of the left pixel coordinate u′_{L}, v′_{L} of the left epipolar image, the detected change

$$\frac{d}{dt} {H}_{R}^{E} ( {u}_{R}^{′} , {v}_{R}^{′} , t )$$

in the appearance of the right pixel coordinate u′_{R}, v′_{R} of the right epipolar image, and the time t of the event. In some examples, the event stream coordinator circuitry 125 sends separate appearance change values for the three different hue, saturation and intensity channels of the left and right epipolar values such that the appearance change values are

$$\frac{d}{dt} {{H}^{E}}_{k ( {u}^{′} , {v}^{′} , t )} ∈ {[ - {2}^{( n - 1 )} , {2}^{( n - 1 )} ]}^{3} ,$$

that is, they are n bit resolution values.

As another example, for a voxel associated with a dual spatial-chromatic event, the event stream coordinator circuitry 125 creates an event data structure or event data packet represented by Equation 9, which is:

$${λ}_{i}^{sc} := [ {x}_{c} = {ω}_{x} ( {u}_{L}^{′} , {v}_{L}^{′} , {u}_{R}^{′} , {v}_{R}^{′} ) , {y}_{c} = {ω}_{y} ( {u}_{L}^{′} , {v}_{L}^{′} , {u}_{R}^{′} , {v}_{R}^{′} ) , {z}_{c =} {ω}_{z} ( {u}_{L}^{′} , {v}_{L}^{′} , {u}_{R}^{′} , {v}_{R}^{′} ) , \pm r , {u}_{L}^{′} , {v}_{L}^{′} , {u}_{R}^{′} , {v}_{R}^{′} , \frac{d}{dt} {H}_{L}^{E} ( {u}_{L}^{′} , {v}_{L}^{′} , t ) , \frac{d}{dt} {H}_{R}^{E} ( {u}_{R}^{′} , {v}_{R}^{′} , t ) , t ] \qquad Equation 9$$

Thus, the dual spatial-chromatic event data structure or data packet of Equation 9 includes the center (x_{c}, y_{c}, z_{c}) of the voxel corresponding to the spatial event in the x, y and z dimensions, the radius r of the voxel in the volumetric scene (with the sign of the radius indicating a spatial addition or subtraction event), the left pixel coordinate u′_{L}, v′_{L} of the left epipolar image and the right pixel coordinate u′_{R}, v′_{R} of the right epipolar image corresponding to the chromatic event, the detected change

$$\frac{d}{dt} {H}_{L}^{E} ( {u}_{L}^{′} , {v}_{L}^{′} , t )$$

in the appearance of the left pixel coordinate u′_{L}, v′_{L} of the left epipolar image, the detected change

$$\frac{d}{dt} {H}_{R}^{E} ( {u}_{R}^{′} , {v}_{R}^{′} , t )$$

in the appearance of the right pixel coordinate u′_{R}, v′_{R} of the right epipolar image, and the time t of the event.

Because the events of the event vectors 525 (φ_{(u′}_{ᵢ}_{,t)}) can occur asynchronously, in some examples, the event stream coordinator circuitry 125 generates and outputs/transmits a signature, also referred to as a signature data structure or signature packet, prior to the events of the event vectors 525 (φ_{(u′}_{ᵢ}_{,t)}) In some examples, the signature generated by the event stream coordinator circuitry 125 is a starting byte sequence of {0xAA,0xBB, 0xCC}, or some other sequence, to enable the receiving computer vision applications 110 to properly detect and decode the event data.

In summary, and based on the foregoing description, in some examples the epipolar-based event detector 120 includes the epipolar scan line rectifier circuitry 160 and 165 to rectify left input image data and right input image data based on an epipolar geometric transformation to generate left epipolar image data and right epipolar image data. As described above, the left epipolar image data includes a plurality of left epipolar scan lines, and the right epipolar image data including a plurality of right epipolar scan lines.

In some examples, the epipolar-based event detector 120 also implements a neural processor array, such as the epipolar scan line neural processor array 170, including a plurality of neural processors, such as the epipolar scan line neural processors 175, with respective ones of the neural processors to process respective pairs of the left epipolar scan lines and the right epipolar scan lines to detect events represented in the left input image data and the right input image data. In some examples, the epipolar-based event detector 120 further includes the event stream coordinator circuitry 125 to output data packets representative of the detected events.

As disclosed above, in some examples, a given one of the epipolar scan line neural processors 175 of the epipolar scan line neural processor array 170 includes an input layer 505 to accept one of the left epipolar scan lines and a corresponding one of the right epipolar scan lines. In some examples, the given epipolar scan line neural processor 175 also includes at least one hidden layer 510, and an output layer to output the event vector 525, which is representative of ones of the detected events associated with the input left epipolar scan line and right epipolar scan line. In some examples, the output layer 515 is also to output the disparity vector 520, which includes disparity values estimated by the given epipolar scan line neural processor 175 between pixels of the input left epipolar scan lines and corresponding pixels of the input right epipolar scan line. As described above, the disparity values are convertible to spatial distances or depths.

In some examples, the disparity vector output from the output layer 515 of the given epipolar scan line neural processor 175 is a first disparity vector output for a first process iteration of the given epipolar scan line neural processor 175, and the input layer 505 of the given epipolar scan line neural processor 175 is also to accept a second disparity vector corresponding to a second process iteration of the given epipolar scan line neural processor 175, with the second process iteration prior to the first process iteration.

In some examples, the event vector output from the output layer 515 of the given epipolar scan line neural processor 175 includes entries corresponding respectively to ones of a plurality of epipolar volumetric elements represented by corresponding pixels of the input left epipolar scan line and corresponding pixels of the input right epipolar scan line. In some examples, the entries of the event vector include data representative of types of events detected for the ones of the epipolar volumetric elements. For example, the types of the events can include a chromatic event, a spatial event, a dual chromatic and spatial event, and no detected event.

In some examples, the left input image data is first left input image data, the right input image data is first right input image data, and the epipolar-based event detector 120 includes interface circuitry, such as the color space transformer circuitry 140 and 145, to access second left input image data and second right input image data from a stereo imaging device, such as the stereo imagers 115. In some such examples, the epipolar-based event detector 120 includes the image downsampler circuitry 150 and 155 to downsample the second left input image data to obtain the first left input image data, and to downsample the second right input image data to obtain the first right input image data. In some such examples, the epipolar scan line rectifier circuitry 160 and 165 of the epipolar-based event detector 120 is to rectify the first left input image data and the first right input image data based on the epipolar geometric transformation to generate the left epipolar image data and the right epipolar image data.

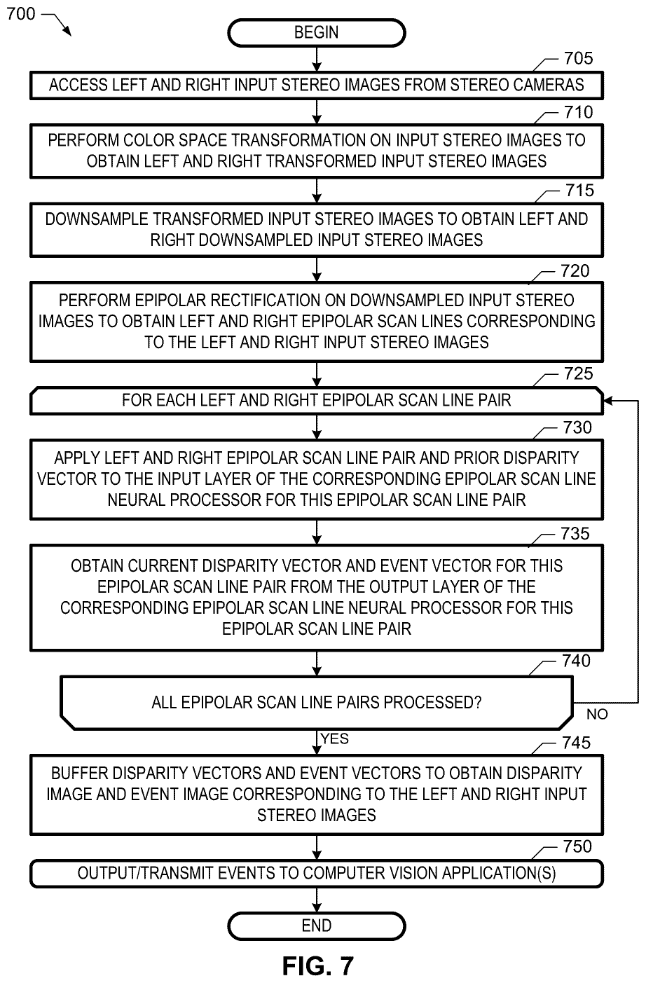

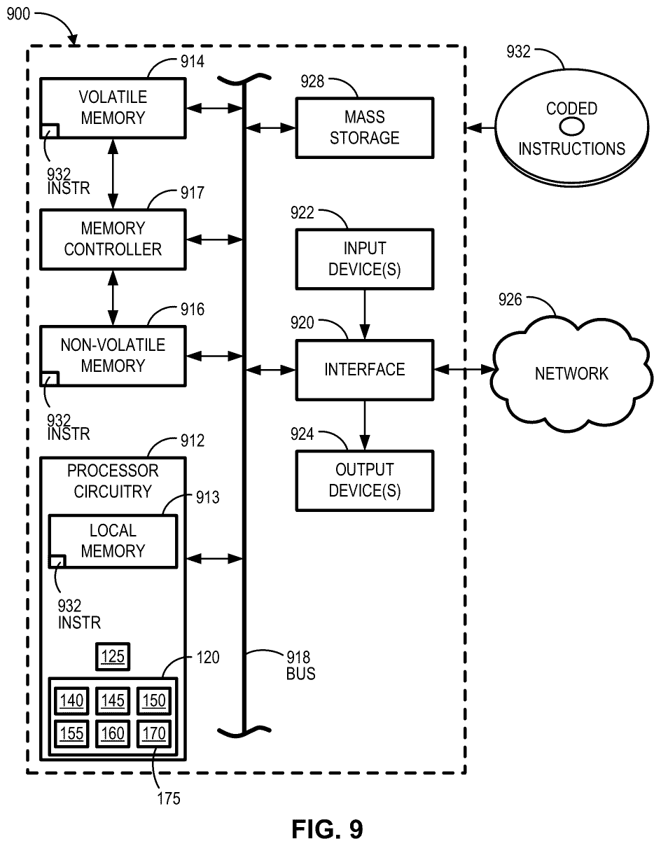

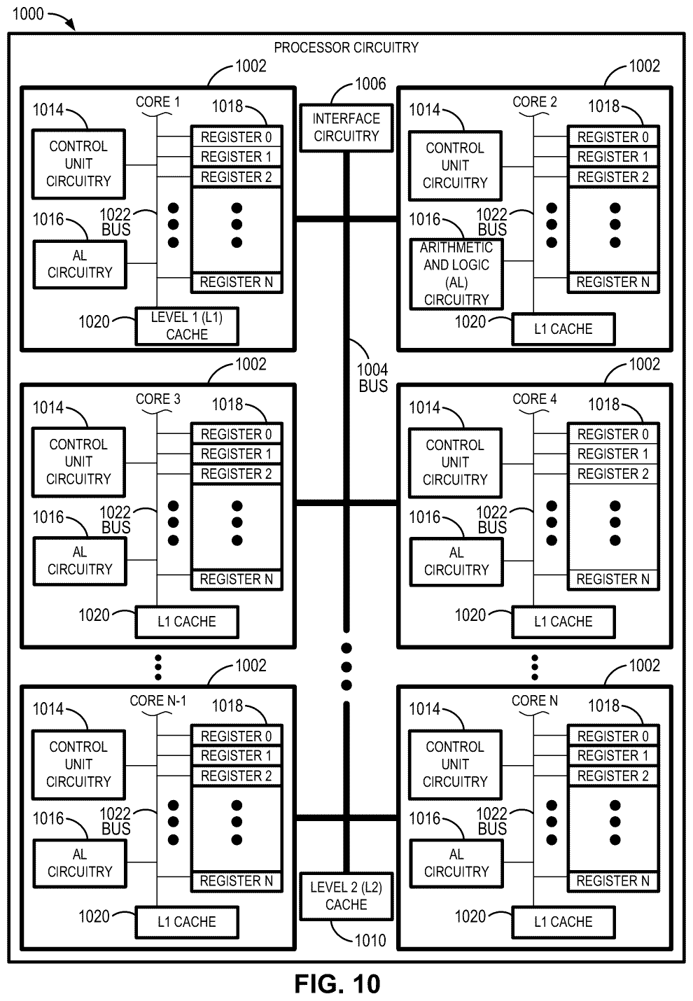

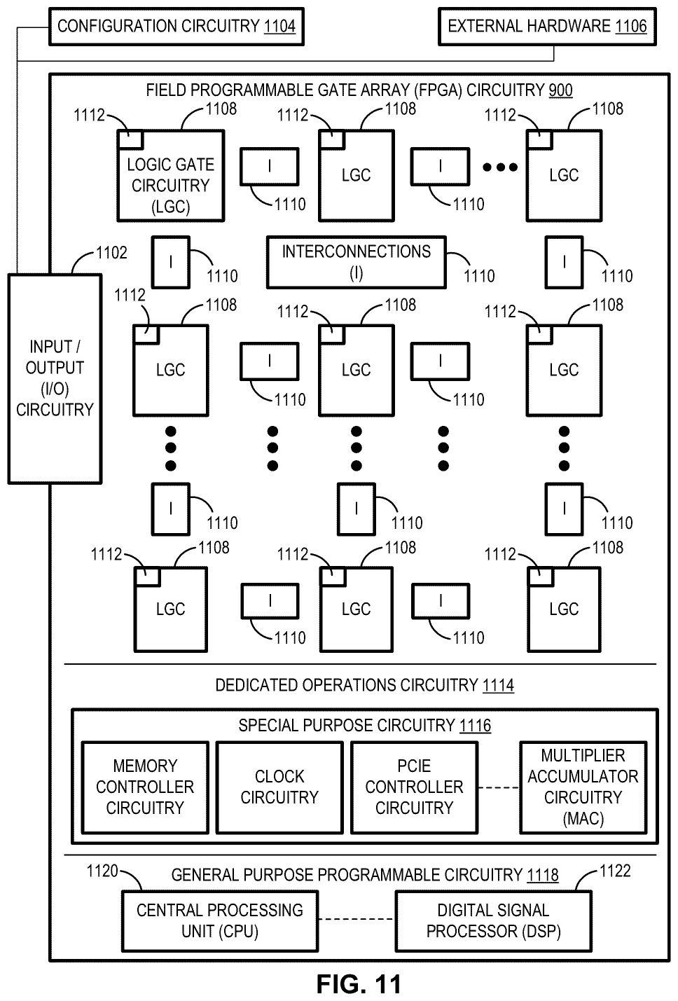

In some examples, the 4D event camera 105 includes means for performing color space transformation of images. For example, the means for performing color space transformation of images may be implemented by the color space transformer circuitry 140 and 145. In some examples, the color space transformer circuitry 140 and 145 may be instantiated by programmable circuitry such as the example programmable circuitry 912 of FIG. 9. For instance, the color space transformer circuitry 140 and 145 may be instantiated by the example microprocessor 1000 of FIG. 10 executing machine executable instructions such as those implemented by at least blocks 705 and 710 of FIG. 7. In some examples, the color space transformer circuitry 140 and 145 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the color space transformer circuitry 140 and 145 may be instantiated by any other combination of hardware, software, and/or firmware. For example, the color space transformer circuitry 140 and 145 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the 4D event camera 105 includes means for downsampling images. For example, the means for downsampling images may be implemented by the image downsampler circuitry 150 and 155. In some examples, the image downsampler circuitry 150 and 155 may be instantiated by programmable circuitry such as the example programmable circuitry 912 of FIG. 9. For instance, the image downsampler circuitry 150 and 155 may be instantiated by the example microprocessor 1000 of FIG. 10 executing machine executable instructions such as those implemented by at least block 715 of FIG. 7. In some examples, the image downsampler circuitry 150 and 155 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the image downsampler circuitry 150 and 155 may be instantiated by any other combination of hardware, software, and/or firmware. For example, the image downsampler circuitry 150 and 155 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the 4D event camera 105 includes means for rectifying images by, for example, performing epipolar transformations on the images. For example, the means for rectifying images may be implemented by the epipolar scan line rectifier circuitry 160 and 165. In some examples, the epipolar scan line rectifier circuitry 160 and 165 may be instantiated by programmable circuitry such as the example programmable circuitry 912 of FIG. 9. For instance, the epipolar scan line rectifier circuitry 160 and 165 may be instantiated by the example microprocessor 1000 of FIG. 10 executing machine executable instructions such as those implemented by at least block 720 of FIG. 7. In some examples, the epipolar scan line rectifier circuitry 160 and 165 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the epipolar scan line rectifier circuitry 160 and 165 may be instantiated by any other combination of hardware, software, and/or firmware. For example, the epipolar scan line rectifier circuitry 160 and 165 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the 4D event camera 105 includes means for processing epipolar images to detect events. For example, the means for processing epipolar images may be implemented by the epipolar scan line neural processor array 170. In some examples, the epipolar scan line neural processor array 170 may be instantiated by programmable circuitry such as the example programmable circuitry 912 of FIG. 9. For instance, the epipolar scan line neural processor array 170 may be instantiated by the example microprocessor 1000 of FIG. 10 executing machine executable instructions such as those implemented by at least blocks 725-740 of FIG. 7. In some examples, the epipolar scan line neural processor array 170 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the epipolar scan line neural processor array 170 may be instantiated by any other combination of hardware, software, and/or firmware. For example, the epipolar scan line neural processor array 170 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

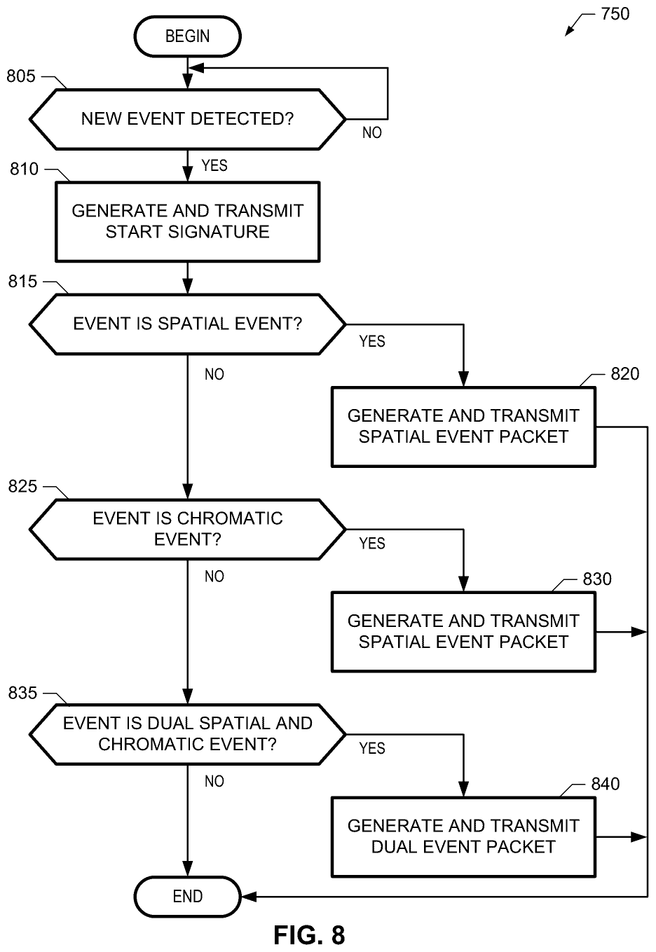

In some examples, the 4D event camera 105 includes means for means for packaging and transmitting detect events. For example, the means for packaging and transmitting detect events may be implemented by the event stream coordinator circuitry 125. In some examples, the event stream coordinator circuitry 125 may be instantiated by programmable circuitry such as the example programmable circuitry 912 of FIG. 9. For instance, the event stream coordinator circuitry 125 may be instantiated by the example microprocessor 1000 of FIG. 10 executing machine executable instructions such as those implemented by at least blocks 745-750 of FIG. 7 and/or blocks 805-840 of FIG. 8. In some examples, the event stream coordinator circuitry 125 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the event stream coordinator circuitry 125 may be instantiated by any other combination of hardware, software, and/or firmware. For example, the event stream coordinator circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the 4D event camera 105 is illustrated in FIG. 1, one or more of the elements, processes, and/or devices illustrated in FIG. 1 may be combined, divided, re-arranged, omitted, eliminated, and/or implemented in any other way. Further, the example stereo imagers 115, the example epipolar-based event detector 120, the example event stream coordinator circuitry 125, the example color space transformer circuitry 140 and 145, the example image downsampler circuitry 150 and 155, the example epipolar scan line rectifier circuitry 160 and 165, the example epipolar scan line neural processor array 170, the example epipolar scan line neural processors 175 and/or, more generally, the example 4D event camera 105 of FIG. 1, may be implemented by hardware alone or by hardware in combination with software and/or firmware. Thus, for example, any of the example stereo imagers 115, the example epipolar-based event detector 120, the example event stream coordinator circuitry 125, the example color space transformer circuitry 140 and 145, the example image downsampler circuitry 150 and 155, the example epipolar scan line rectifier circuitry 160 and 165, the example epipolar scan line neural processor array 170, the example epipolar scan line neural processors 175 and/or, more generally, the example 4D event camera 105 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example 4D event camera 105 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the epipolar-based event detector 120 and the event stream coordinator circuitry 125 of FIG. 1 and/or representative of example operations which may be performed by programmable circuitry to implement and/or instantiate the epipolar-based event detector 120 and the event stream coordinator circuitry 125 of FIG. 1, are shown in FIGS. 7-8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-8, many other methods of implementing the example epipolar-based event detector 120 and the event stream coordinator circuitry 125 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

FIG. 7 is a flowchart representative of example machine readable instructions and/or example operations 700 that may be executed, instantiated, and/or performed by programmable circuitry to implement the example epipolar-based event detector 120 and the example event stream coordinator circuitry 125 of FIGS. 1-6. The example machine-readable instructions and/or the example operations 700 of FIG. 7 begin at block 705, at which the color space transformer circuitry 140 and 145 is to access left and right input stereo images from stereo cameras, such as the stereo imagers 115, as described above. At block 710, the color space transformer circuitry 140 and 145 is to perform color transformation on the input stereo images to obtain left and right transformed input stereo images, as described above. At block 715, the image downsampler circuitry 150 and 155 is to downsample the transformed input stereo images to obtain left and right downsampled input stereo images, as described above. At block 720, the epipolar scan line rectifier circuitry 160 and 165 is to perform epipolar rectification on the downsampled input stereo images to obtain left and right epipolar images containing left and right epipolar scan lines corresponding to the left and right input stereo images, as described above.

At block 725, the epipolar scan line neural processor array 170 begins processing respective left and right epipolar scan line pairs, as described above. For example, at block 730, a given left and right epipolar scan line pair 530-535 is applied to the input layer 505 of the corresponding epipolar scan line neural processor 175 assigned to that epipolar scan line pair. At block 735, the disparity vector 520 and the event vector 525 determined by that epipolar scan line neural processor 175 for the given left and right epipolar scan line pair 530-535 is obtained at the output layer 515 of the epipolar scan line neural processor 175, as described above. At block 740, the epipolar scan line neural processor array 170 continues processing until all respective left and right epipolar scan line pairs have been processed.

At block 745, the event stream coordinator circuitry 125 buffers (e.g., concatenates) the disparity vectors 520 and the event vectors 525 determined by the epipolar scan line neural processor array 170 for the respective left and right epipolar scan line pairs to obtain the depth image 605 and the event image 610 corresponding to the input stereo images, as described above. At block 750, the event stream coordinator circuitry 125 outputs/transmits the detected occupancy events to the computer vision applications 110, as described above. The example machine-readable instructions and/or the example operations 700 then end.

FIG. 8 is a flowchart representative of example machine readable instructions and/or example operations 750 that may be executed, instantiated, and/or performed by programmable circuitry to implement the processing at block 750 of FIG. 7. The example machine-readable instructions and/or the example operations 750 of FIG. 8 begin at block 805, at which the event stream coordinator circuitry 125 determines whether a new occupancy event was detected and output by the epipolar scan line neural processor array 170. If a new occupancy event was detected, at block 810 the event stream coordinator circuitry 125 generates a start signature, as described above. At block 815, the event stream coordinator circuitry 125 determines whether the detected event is a spatial event. If the event is a spatial event (corresponding to the YES output of block 815), then at block 820 the event stream coordinator circuitry 125 generates and outputs/transmits a spatial event packet or data structure, as described above. If the event is not a spatial event (corresponding to the NO output of block 815), then at block 825 the event stream coordinator circuitry 125 determines whether the detected event is a chromatic event. If the event is a chromatic event (corresponding to the YES output of block 825), then at block 830 the event stream coordinator circuitry 125 generates and outputs/transmits a chromatic event packet or data structure, as described above. If the event is not a chromatic event (corresponding to the NO output of block 825), then at block 835 the event stream coordinator circuitry 125 determines whether the detected event is a dual spatial and chromatic event. If the event is a dual spatial and chromatic event (corresponding to the YES output of block 835), then at block 840 the event stream coordinator circuitry 125 generates and outputs/transmits a dual spatial and chromatic event packet or data structure, as described above. If the event is not a dual spatial and chromatic event (corresponding to the NO output of block 835), then no event packet or data structure is generated by the event stream coordinator circuitry 125. The example machine-readable instructions and/or the example operations 750 then end.

FIG. 9 is a block diagram of an example programmable circuitry platform 900 structured to execute and/or instantiate the example machine-readable instructions and/or the example operations of FIGS. 7-8 to implement the epipolar-based event detector 120 and the event stream coordinator circuitry 125 of FIG. 1. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example epipolar-based event detector 120, the example event stream coordinator circuitry 125, the example color space transformer circuitry 140 and 145, the example image downsampler circuitry 150 and 155, the example epipolar scan line rectifier circuitry 160 and 165, the example epipolar scan line neural processor array 170 and/or the example epipolar scan line neural processors 175.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 7-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 7-8 to effectively instantiate the circuitry of FIG. 2 as logic circuits to perform operations corresponding to those machine readable instructions. In some such examples, the circuitry of FIG. 1 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 7-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 7-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-8. As such, the FPGA circuitry 1100 may be configured and/or structured to effectively instantiate some or all of the operations/functions corresponding to the machine readable instructions of the flowchart(s) of FIGS. 7-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 7-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 7-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 7-8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIG. 7-8, and/or an ASIC may be configured and/or structured to perform third operation(s)/function(s) corresponding to a third portion of the machine readable instructions represented by the flowcharts of FIGS. 7-8.

It should be understood that some or all of the circuitry of FIG. 1 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 1 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

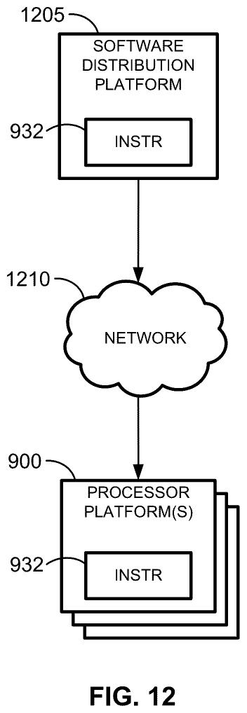

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 7-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIG. 7-8, may be downloaded to the example programmable circuitry platform 900, which is to execute the machine readable instructions 932 to implement the epipolar-based event detector 120 and the event stream coordinator circuitry 125. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that implement and utilize epipolar scan line neural processor arrays for four-dimensional event detection and identification. Disclosed systems, apparatus, articles of manufacture, and methods improve the efficiency of a computing device, such as a 4D event camera, by exploiting the epipolar geometry of the captured volumetric scene to improve event detection accuracy and to enable processing of image scan lines in parallel, thereby reducing latency. Disclosed systems, apparatus, articles of manufacture, and methods are accordingly directed to one or more improvement(s) in the operation of a machine such as a computer or other electronic and/or mechanical device.

Further examples and combinations thereof include the following:

Example 1 includes an apparatus comprising interface circuitry, computer readable instructions, and programmable circuitry. The programmable circuitry is to utilize the computer readable instructions to generate, based on left input image data and right input image data, left epipolar image data and right epipolar image data, the left epipolar image data including a plurality of left epipolar scan lines, the right epipolar image data including a plurality of right epipolar scan lines. The apparatus of example 1 is also to process, with respective neural processors, respective pairs of the left epipolar scan lines and the right epipolar scan lines to detect events represented in the left input image data and the right input image data, and output data packets representative of the detected events.

Example 2 includes the apparatus of example 1, wherein the neural processors are included in a neural processor array, and a first one of the neural processors of the neural processor array includes an input layer to accept a first one of the left epipolar scan lines and a first one of the right epipolar scan lines, a hidden layer, and an output layer to output an event vector representative of the detected events associated with the first one of the left epipolar scan lines and the first one of the right epipolar scan lines.

Example 3 includes the apparatus of example 2, wherein the output layer is to output a disparity vector including disparity values estimated by the first one of the neural processors between pixels of the first one of the left epipolar scan lines and corresponding pixels of the first one of the right epipolar scan lines, the disparity values convertible to spatial distances.

Example 4 includes the apparatus of example 3, wherein the disparity vector is a first disparity vector output for a first process iteration of the first one of the neural processors, and the input layer is to accept a second disparity vector corresponding to a second process iteration of the first one of the neural processors, the second process iteration prior to the first process iteration.

Example 5 includes the apparatus of example 2, wherein the event vector includes entries corresponding respectively to epipolar volumetric elements represented by corresponding pixels of the first one of the left epipolar scan lines and corresponding pixels of the first one of the right epipolar scan lines, the entries including data representative of types of events detected for the epipolar volumetric elements.

Example 6 includes the apparatus of example 5, wherein the types of the events include at least one of a chromatic event, a spatial event, or a dual chromatic and spatial event.

Example 7 includes the apparatus of example 1, wherein the left input image data is first left input image data, the right input image data is first right input image data, and the interface circuitry is to access second left input image data and second right input image data from a stereo imaging device, and the programmable circuitry is to downsample the second left input image data to obtain the first left input image data, downsample the second right input image data to obtain the first right input image data, and rectify the first left input image data and the first right input image data based on an epipolar geometric transformation to generate the left epipolar image data and the right epipolar image data.

Example 8 includes the apparatus of example 1, wherein the programmable circuitry includes one or more of at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations.

Example 9 includes at least one non-transitory machine readable storage medium comprising instructions to cause programmable circuitry to at least generate, based on left input image data and right input image data, left epipolar image data and right epipolar image data, the left epipolar image data including a plurality of left epipolar scan lines, the right epipolar image data including a plurality of right epipolar scan lines, process, with respective neural processors, respective pairs of the left epipolar scan lines and the right epipolar scan lines to detect events represented in the left input image data and the right input image data, and output a data structure including elements representative of the detected events.

Example 10 includes the at least one non-transitory machine readable storage medium of example 9, wherein the neural processors are included in a neural processor array, and for a first one of the neural processors in the neural processor array, the instructions are to cause the programmable circuitry to implement an input layer to accept a first one of the left epipolar scan lines and a first one of the right epipolar scan lines, a hidden layer, and an output layer to output an event vector to include in the data structure, the event vector representative of the detected events associated with the first one of the left epipolar scan lines and the first one of the right epipolar scan lines.

Example 11 includes the at least one non-transitory machine readable storage medium of example 10, wherein the instructions are to cause the programmable circuitry to implement the output layer to output a disparity vector including disparity values estimated by the first one of the neural processors between pixels of the first one of the left epipolar scan lines and corresponding pixels of the first one of the right epipolar scan lines, the disparity values convertible to spatial distances.

Example 12 includes the at least one non-transitory machine readable storage medium of example 11, wherein the disparity vector is a first disparity vector output for a first process iteration of the first one of the neural processors, and the instructions are to cause the programmable circuitry to implement the input layer to accept a second disparity vector corresponding to a second process iteration of the first one of the neural processors, the second process iteration prior to the first process iteration.

Example 13 includes the at least one non-transitory machine readable storage medium of example 10, wherein the event vector includes entries corresponding respectively to epipolar volumetric elements represented by corresponding pixels of the first one of the left epipolar scan lines and corresponding pixels of the first one of the right epipolar scan lines, the entries including data representative of types of events detected for the epipolar volumetric elements.

Example 14 includes the at least one non-transitory machine readable storage medium of example 13, wherein the types of the events include at least one of a chromatic event, a spatial event, or a dual chromatic and spatial event.

Example 15 includes a method comprising generating, based on left input image data and right input image data, left epipolar image data and right epipolar image data, the left epipolar image data including a plurality of left epipolar scan lines, the right epipolar image data including a plurality of right epipolar scan lines, processing respective pairs of the left epipolar scan lines and the right epipolar scan lines with respective ones of a plurality of neural processors to detect events represented in the left input image data and the right input image data, and transmitting data packets representative of the detected events to a computer vision application.

Example 16 includes the method of example 15, wherein the processing of the respective pairs of the left epipolar scan lines and the right epipolar scan lines includes applying a first one of the left epipolar scan lines and a first one of the right epipolar scan lines to an input layer of a first one of the neural processors, processing outputs of the input layer with a hidden layer, and processing outputs of the hidden layer with an output layer to obtain an event vector representative of the detected events associated with the first one of the left epipolar scan lines and the first one of the right epipolar scan lines.

Example 17 includes the method of example 16, wherein the processing of the outputs of the hidden layer with the output layer is also to obtain a disparity vector including disparity values estimated by the first one of the neural processors between pixels of the first one of the left epipolar scan lines and corresponding pixels of the first one of the right epipolar scan lines, the disparity values convertible to spatial distances.

Example 18 includes the method of example 17, wherein the disparity vector is a first disparity vector obtained for a first processing iteration of the first one of the neural processors, and further including applying a second disparity vector to the input layer, the second disparity vector corresponding to a second processing iteration of the first one of the neural processors, the second processing iteration prior to the first process iteration.

Example 19 includes the method of example 16, wherein the event vector includes entries corresponding respectively to epipolar volumetric elements represented by corresponding pixels of the first one of the left epipolar scan lines and corresponding pixels of the first one of the right epipolar scan lines, the entries including data representative of types of events detected for the epipolar volumetric elements.

Example 20 includes the method of example 19, wherein the types of the events include at least one of a chromatic event, a spatial event, or a dual chromatic and spatial event.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
computer readable instructions; and
programmable circuitry to utilize the computer readable instructions to:
generate, based on left input image data and right input image data, left epipolar image data and right epipolar image data, the left epipolar image data including a plurality of left epipolar scan lines, the right epipolar image data including a plurality of right epipolar scan lines;
process, with respective neural processors, respective pairs of the left epipolar scan lines and the right epipolar scan lines to detect events represented in the left input image data and the right input image data; and
output data packets representative of the detected events.

2. The apparatus of claim 1, wherein the neural processors are included in a neural processor array, and a first one of the neural processors of the neural processor array includes:
an input layer to accept a first one of the left epipolar scan lines and a first one of the right epipolar scan lines;
a hidden layer; and
an output layer to output an event vector representative of the detected events associated with the first one of the left epipolar scan lines and the first one of the right epipolar scan lines.

3. The apparatus of claim 2, wherein the output layer is to output a disparity vector including disparity values estimated by the first one of the neural processors between pixels of the first one of the left epipolar scan lines and corresponding pixels of the first one of the right epipolar scan lines, the disparity values convertible to spatial distances.

4. The apparatus of claim 3, wherein the disparity vector is a first disparity vector output for a first process iteration of the first one of the neural processors, and the input layer is to accept a second disparity vector corresponding to a second process iteration of the first one of the neural processors, the second process iteration prior to the first process iteration.

5. The apparatus of claim 2, wherein the event vector includes entries corresponding respectively to epipolar volumetric elements represented by corresponding pixels of the first one of the left epipolar scan lines and corresponding pixels of the first one of the right epipolar scan lines, the entries including data representative of types of events detected for the epipolar volumetric elements.

6. The apparatus of claim 5, wherein the types of the events include at least one of:
a chromatic event;
a spatial event; or
a dual chromatic and spatial event.

7. The apparatus of claim 1, wherein the left input image data is first left input image data, the right input image data is first right input image data, and:
the interface circuitry is to access second left input image data and second right input image data from a stereo imaging device; and
the programmable circuitry is to:
downsample the second left input image data to obtain the first left input image data;
downsample the second right input image data to obtain the first right input image data; and
rectify the first left input image data and the first right input image data based on an epipolar geometric transformation to generate the left epipolar image data and the right epipolar image data.

8. The apparatus of claim 1, wherein the programmable circuitry includes one or more of:
at least one of a central processor unit, a graphics processor unit, or a digital signal processor, the at least one of the central processor unit, the graphics processor unit, or the digital signal processor having control circuitry to control data movement within the programmable circuitry, arithmetic and logic circuitry to perform one or more first operations corresponding to machine-readable data, and one or more registers to store a result of the one or more first operations, the machine-readable data in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations.

9. At least one non-transitory machine readable storage medium comprising instructions to cause programmable circuitry to at least:
generate, based on left input image data and right input image data, left epipolar image data and right epipolar image data, the left epipolar image data including a plurality of left epipolar scan lines, the right epipolar image data including a plurality of right epipolar scan lines;
process, with respective neural processors, respective pairs of the left epipolar scan lines and the right epipolar scan lines to detect events represented in the left input image data and the right input image data; and
output a data structure including elements representative of the detected events.

10. The at least one non-transitory machine readable storage medium of claim 9, wherein the neural processors are included in a neural processor array, and for a first one of the neural processors in the neural processor array, the instructions are to cause the programmable circuitry to implement:
an input layer to accept a first one of the left epipolar scan lines and a first one of the right epipolar scan lines;
a hidden layer; and
an output layer to output an event vector to include in the data structure, the event vector representative of the detected events associated with the first one of the left epipolar scan lines and the first one of the right epipolar scan lines.

11. The at least one non-transitory machine readable storage medium of claim 10, wherein the instructions are to cause the programmable circuitry to implement the output layer to output a disparity vector including disparity values estimated by the first one of the neural processors between pixels of the first one of the left epipolar scan lines and corresponding pixels of the first one of the right epipolar scan lines, the disparity values convertible to spatial distances.

12. The at least one non-transitory machine readable storage medium of claim 11, wherein the disparity vector is a first disparity vector output for a first process iteration of the first one of the neural processors, and the instructions are to cause the programmable circuitry to implement the input layer to accept a second disparity vector corresponding to a second process iteration of the first one of the neural processors, the second process iteration prior to the first process iteration.

13. The at least one non-transitory machine readable storage medium of claim 10, wherein the event vector includes entries corresponding respectively to epipolar volumetric elements represented by corresponding pixels of the first one of the left epipolar scan lines and corresponding pixels of the first one of the right epipolar scan lines, the entries including data representative of types of events detected for the epipolar volumetric elements.

14. The at least one non-transitory machine readable storage medium of claim 13, wherein the types of the events include at least one of:
a chromatic event;
a spatial event; or
a dual chromatic and spatial event.

15. A method comprising:
generating, based on left input image data and right input image data, left epipolar image data and right epipolar image data, the left epipolar image data including a plurality of left epipolar scan lines, the right epipolar image data including a plurality of right epipolar scan lines;
processing respective pairs of the left epipolar scan lines and the right epipolar scan lines with respective ones of a plurality of neural processors to detect events represented in the left input image data and the right input image data; and
transmitting data packets representative of the detected events to a computer vision application.

16. The method of claim 15, wherein the processing of the respective pairs of the left epipolar scan lines and the right epipolar scan lines includes:
applying a first one of the left epipolar scan lines and a first one of the right epipolar scan lines to an input layer of a first one of the neural processors;
processing outputs of the input layer with a hidden layer; and
processing outputs of the hidden layer with an output layer to obtain an event vector representative of the detected events associated with the first one of the left epipolar scan lines and the first one of the right epipolar scan lines.

17. The method of claim 16, wherein the processing of the outputs of the hidden layer with the output layer is also to obtain a disparity vector including disparity values estimated by the first one of the neural processors between pixels of the first one of the left epipolar scan lines and corresponding pixels of the first one of the right epipolar scan lines, the disparity values convertible to spatial distances.

18. The method of claim 17, wherein the disparity vector is a first disparity vector obtained for a first processing iteration of the first one of the neural processors, and further including applying a second disparity vector to the input layer, the second disparity vector corresponding to a second processing iteration of the first one of the neural processors, the second processing iteration prior to the first process iteration.

19. The method of claim 16, wherein the event vector includes entries corresponding respectively to epipolar volumetric elements represented by corresponding pixels of the first one of the left epipolar scan lines and corresponding pixels of the first one of the right epipolar scan lines, the entries including data representative of types of events detected for the epipolar volumetric elements.

20. The method of claim 19, wherein the types of the events include at least one of:
a chromatic event;
a spatial event; or
a dual chromatic and spatial event.
